(19) United States
(12) Patent Application Publication
(10) Pub. No.: US 2019/0063148 A1
(43) Pub. Date: Feb. 28, 2019

(54) REELING DEVICE FOR AUTOMATED VENETIANS

(71) Applicant: SAN HSIN PLASTECH CO., LTD., Taoyuan City (TW)

(72) Inventor: SHU-YUAN CHIANG HUANG, TAOYUAN CITY (TW)

(21) Appl. No.: 15/831,330

(22) Filed: Dec. 4, 2017

(30) Foreign Application Priority Data
Aug. 30, 2017 (TW) 106212834

(51) Int. Cl. E06B 9/322; E06B 9/326; E06B 9/68; E06B 9/327

(52) U.S. Cl. CPC E06B 9/322; E06B 9/326; E06B 9/323; E06B 9/327; E06B 9/68

(57) ABSTRACT

A reeling device for automated venetians is disclosed, including an upper track, a transmission tube, an electric motor, a plurality of reel rotors, a plurality of fixing bases, a plurality of lift cords and ladder tapes. The reel rotors are intervally disposed on the transmission tube, a cord area and a ladder tape area are respectively formed on the surfaces of the plurality of reel rotors, and the cord area and the ladder tape are disposed on the reel rotors in parallel. The fixing bases are disposed at a position that is at the bottom of the upper track and corresponding to the reel rotors, and the fixing bases are disposed below the plurality of reel rotors and have a bottom plate on which a lateral plate is disposed. The cord guiding hole and the lateral plate guide the lift cords to wind at the cord area.

### 1. FIELD OF THE INVENTION

The present disclosure relates to a reeling device for automated venetians; more particularly, to a reeling device for automated venetians capable of raising and lowing slats and adjusting the inclination angle of each of the slats.

### 2. DESCRIPTION OF RELATED ART

Venetians, which are installed on windows of houses and have multiples slats, are applied to control indoor illuminance and to shield lights. Venetians can further be used to increase the aesthetic feeling of interior spaces. Traditionally, manually-controlled venetians proved a laborious undertaking when being used; moreover, the exposed lift cords would result in accidents such as strangulation caused by the entanglement of the lift cords when kids have inappropriate operations. Electric venetians, which control the slats to open or to shield lights by using electric motors, have the effectiveness of saving labor and better safety in utilization.

The current electric venetians utilize electric motors to drive the reel rotor to rotate, so as to use the reel rotors to wind or release the cord to raise and lower the slats. The reel rotor can also be used to drive the ladder tape to adjust the inclination angle of each of the slats, so as to adjust the illuminance. However, the current electric venetians use ladder strings, which are not able to shield lights. Since the slats should be opened with slots for the cords, when the slats are adjusted into a light-shielding mode, lights can penetrate through the slots, which results in poor light-shielding effect. Even though the connection of ladder strings and ladder tapes can be found on the market, the manufacturing cost is much higher and the manufacturing process is labor-wasting and time-consuming.

That is, a reeling device for automated venetians that is capable of improving the above addressed flaws is of critical demand.

### SUMMARY OF THE INVENTION

In concerning the deficiencies as addressed above, a reeling device for automated venetians is provided in the present disclosure. The reeling device for automated venetians is of better effects on light shielding, and saves more costs on manufacturing.

The reeling device for automated venetians, having a plurality of slats, the plurality of slats being disposed with slots as provided in the present disclosure, includes an upper track with an accommodation space formed therein, a transmission tube being disposed in the accommodation space of the upper track, an electric motor connected with the transmission tube, configured to drive the transmission tube to rotate, a plurality of reel rotors being intervally disposed on the transmission tube and sleeved on the transmission tube, a cord area and a ladder tape area being respectively formed on the surfaces of the plurality of reel rotors, in which the ladder tape area is next to the cord area, so as to allow the cord area and the ladder tape area to be disposed on the reel rotors in parallel; a plurality of fixing bases being disposed at a position that is at the bottom of the upper track and corresponding to the plurality of reel rotors, the plurality of fixing bases being disposed below the plurality of reel rotors, the plurality of fixing bases respectively having a bottom plate, a cord guiding hole and two ladder tape guiding grooves being disposed on the bottom plate, the cord guiding hole and the two ladder tape guiding grooves being disposed below the ladder tape of the plurality of reel rotors, a lateral plate being disposed on the bottom plate, and the lateral plate being disposed close to a junction of the cord area and the ladder tape area of the reel rotor; a plurality of lift cords, the cord guiding hole and the lateral plate of the plurality of fixing bases being able to guide the plurality of lift cords to wind at the cord area of the reel rotor, the plurality of lift cords passing through the slots of the slats, and the bottom sides of the plurality of lift cords being connected with the bottommost slat, so as to allow the plurality of reel rotors to wind and release the lift cords to raise and lower the slats, and a plurality of ladder tapes, the ladder tape guiding grooves of the plurality of fixing bases being able to guide the ladder tapes to be disposed across the ladder tape area of the reel rotor, each ladder tape being a wide belt body, the middle parts of the plurality of ladder tapes being disposed across the ladder tape area of the reel rotor, the plurality of ladder tapes having two belt portions, a plurality of bearing portions being disposed between the two belt portions, the slats being disposed on the bearing portions, so as to allow the plurality of reel rotors to drive the ladder tapes to adjust the inclination angle of each of the slats, the ladder tapes corresponding to the slots of the slats, and when the slats are adjusted into a light-shielding mode, the slots of the slats being able to shielded by the ladder tapes.

The effects of the present disclosure are that a cord area and a ladder tape area are respectively formed on the surfaces of the plurality of reel rotors, in which the ladder tape area is next to the cord area, so as to allow the cord area and the ladder tape area to be disposed on the reel rotors in parallel. The plurality of fixing bases are disposed at a position that is at the bottom of the upper track and corresponding to the plurality of reel rotors, and a cord guiding hole and two ladder tape guiding grooves are disposed on the bottom plate, and the lateral plate is disposed close to a junction of the cord area and the ladder tape area of the reel rotor. The cord guiding hole and the lateral plate of the plurality of fixing bases are able to guide the plurality of lift cords to wind at the cord area of the reel rotor, and the ladder tape guiding grooves of the plurality of fixing bases are able to guide the ladder tapes to be disposed across the ladder tape area of the reel rotor. Each ladder tape is a wide belt body. That is, when the slats are adjusted into a light-shielding mode, the slots of the slats are able to be shielded by the ladder tapes, so that a better light shielding effect is achieved. Moreover, as each ladder tape is a wide belt body and unnecessary to be connected with ladder strings, the manufacturing process and cost can be saved.

For further understanding of the present disclosure, the following embodiments are provided along with illustrations to facilitate the disclosure of the present disclosure.

### BRIEF DESCRIPTION OF THE DRAWINGS

FIG. 1 is a 3D view illustrating the reeling device for automated venetians according to the present disclosure;

FIG. 2 is a 3D view illustrating the reeling device for automated venetians according to the present disclosure (with illuminance);

FIG. 3 is a side view illustrating the reeling device for automated venetians according to the present disclosure (with illuminance);

FIG. 4 is a 3D view illustrating the reeling device for automated venetians according to the present disclosure (with light shielded);

FIG. 5 is a side view illustrating the reeling device for automated venetians according to the present disclosure (with light shielded);

FIG. 6 is a sectional view illustrating a partial of the reeling device for automated venetians according to the present disclosure;

FIG. 7 is a 3D decomposition view illustrating the reel rotor and the fixing base according to the present disclosure;

FIG. 8 is a 3D view illustrating the reel rotor and the fixing base according to the present disclosure;

FIG. 9 is a 3D view illustrating the ladder tape area of the fixing base according to the present disclosure;

FIG. 10 is a 3D variation view illustrating the ladder tape area of the fixing base according to the present disclosure;

FIG. 11 is another 3D variation view illustrating the ladder tape area of the fixing base according to the present disclosure;

FIG. 12 is a 3D decomposition view illustrating the fixing base according to the present disclosure;

FIG. 13 is a 3D view illustrating the fixing base according to the present disclosure;

FIG. 14 is a 3D view taken from another angle illustrating the fixing base according to the present disclosure;

FIG. 15 is a 3D view illustrating the connection of the ladder tapes according to the present disclosure;

FIG. 16 is a 3D view illustrating another connection of the ladder tapes according to the present disclosure;

FIG. 17 is a 3D view illustrating yet another connection of the ladder tapes according to the present disclosure;

FIG. 18 is a side view illustrating the connection of the ladder tapes according to the present disclosure;

FIG. 19 is a 3D view illustrating the connection of the ladder apes according to the present disclosure;

FIG. 20 is a schematic view illustrating the portion XX of FIG. 19; and

FIG. 21 is a sectional view illustrating the connection of the ladder tapes according to the present disclosure.

### DETAILED DESCRIPTION OF THE PREFERRED EMBODIMENTS

The aforementioned illustrations and following detailed description are exemplary for the purpose of further explaining the scope of the present disclosure. Other objectives and advantages related to the present disclosure will be illustrated in the following description and appended drawings.

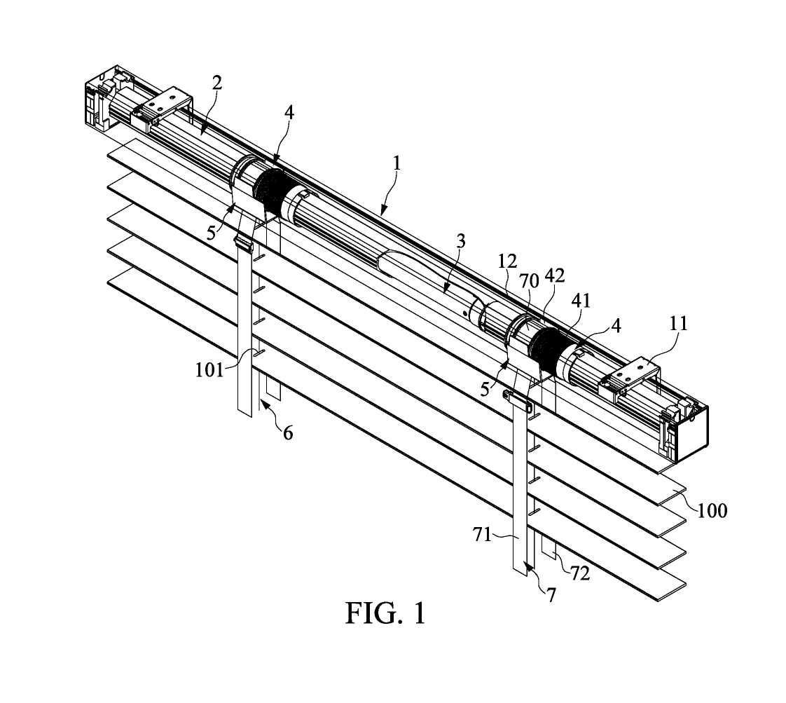

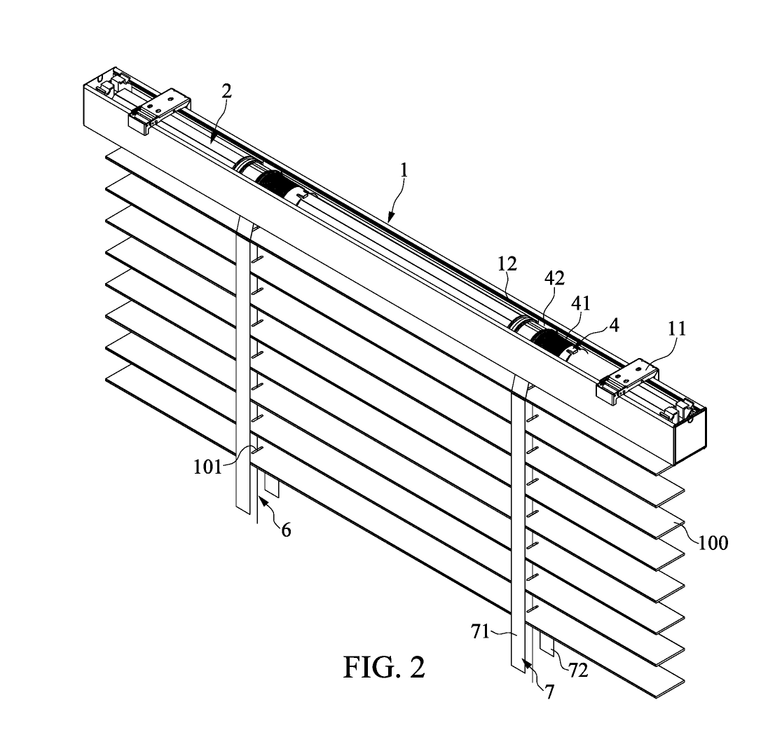

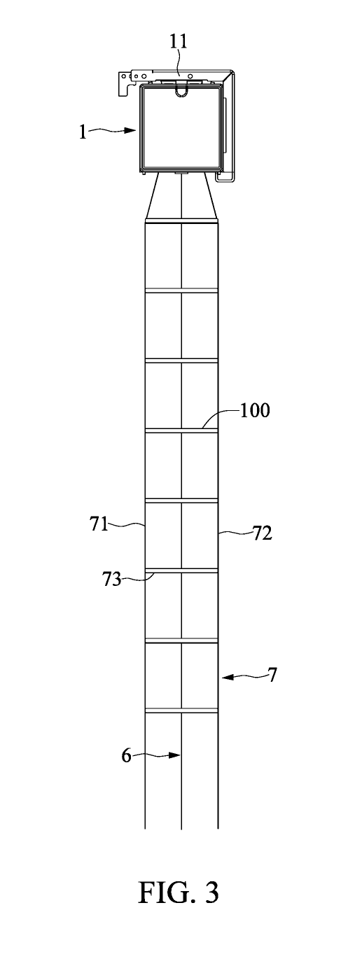

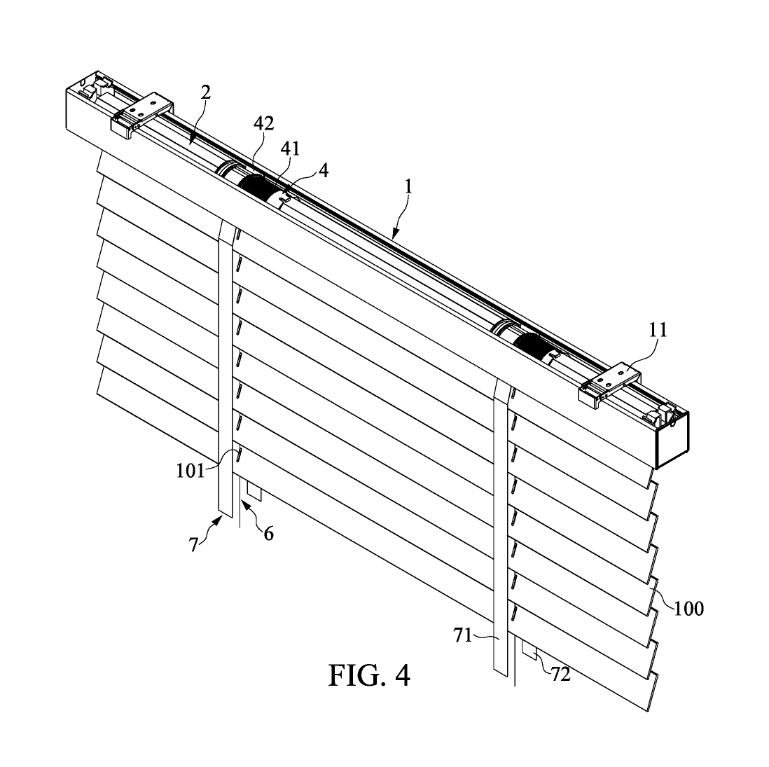

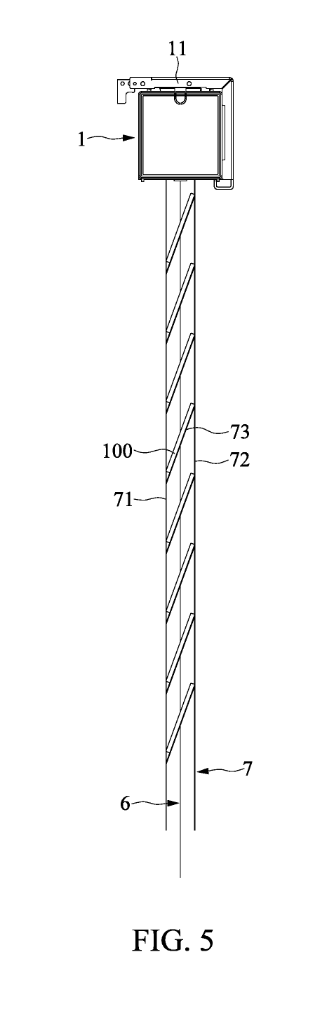

Reference is made to FIG. 1, where FIG. 1 is a 3D view illustrating the reeling device for automated venetians according to the present disclosure. The automated venetians has a plurality of slats 100, and the reeling device can control (drive) the slats 100 to ascend or to descend, also to adjust the inclination angle of each of the slats 100 (as shown in FIGS. 2-5). The reeling device includes an upper track 1, a transmission tube 2, an electric motor 3, a plurality of reel rotors 4, a plurality of fixing bases 5, a plurality of lift cords 6 and a plurality of ladder tapes 7.

The upper track 1 can be, but not limited to, a metal element. In the present embodiment, the upper track 1 is an aluminum track. The upper track 1 can be fixed on a building by, such as a frame 11 or the like. The upper track 1 has an accommodation space 12 formed therein, and the top portion of the accommodation space 12 can be in an opening shape.

The transmission tube 2 is disposed in the accommodation space 12 of the upper track 1. The transmission tube 2 can be, but not limited to, a metal element. In the preset embodiment, the transmission tube 2 is an aluminum tube. The electric motor (tube-shaped motor) 3 can be disposed inside the transmission tube 2, and the electric motor 3 can be connected with the transmission tube 2 through the current transmission mechanism, so that the electric motor 3 can be used to drive the transmission tube 2 to rotate. Since the upper track 1, the transmission tube 2 and the electric motor 3 are well known to people with ordinary skill in the art, the details with respect thereto will be omitted for the sake of brevity.

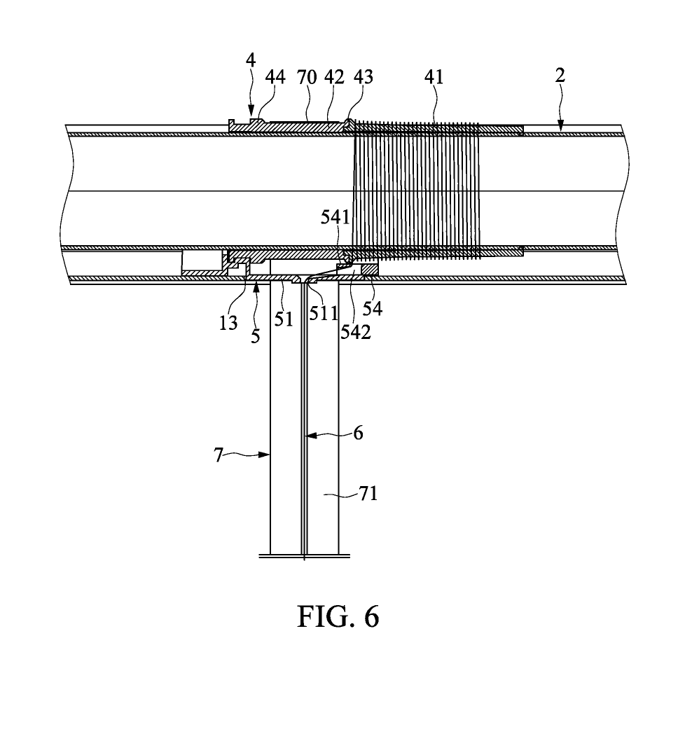

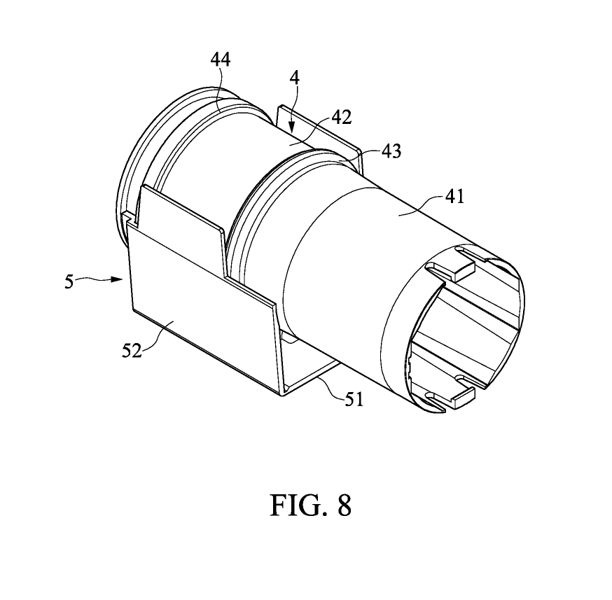

The plurality of reel rotors 4 are intervally disposed on the transmission tube 2. The plurality of reel rotors 4 can be, but not limited to, a plastic element. The reel rotor 4 is a hollow cylinder, and sleeves on the transmission tube 2. The reel rotor 4 can be fixed on the transmission tube 2 through, engagement, adhesion, screw attachment or the like. Reference is next made to FIGS. 6-8. A cord area 41 and a ladder tape area 42 are formed on the surfaces of the reel rotor 4, in which the ladder tape area 42 is next to the rope-pulling area 41, so as to allow the rope-pulling area 41 and the ladder tape area 42 to be disposed on the reel rotors in parallel, which implies that the rope-pulling area 41 and the ladder tape area 42 are staggered. The widths of the cord area 41 and the ladder tape area 42 can be adjusted. Ring-shaped protrusion 43, 44 are disposed at the two sides of the ladder tape area 42, for position limit to the ladder tape 7. The ring-shaped protrusion 43, 44 can also be used to space the cord area 41 and the ladder tape area 42.

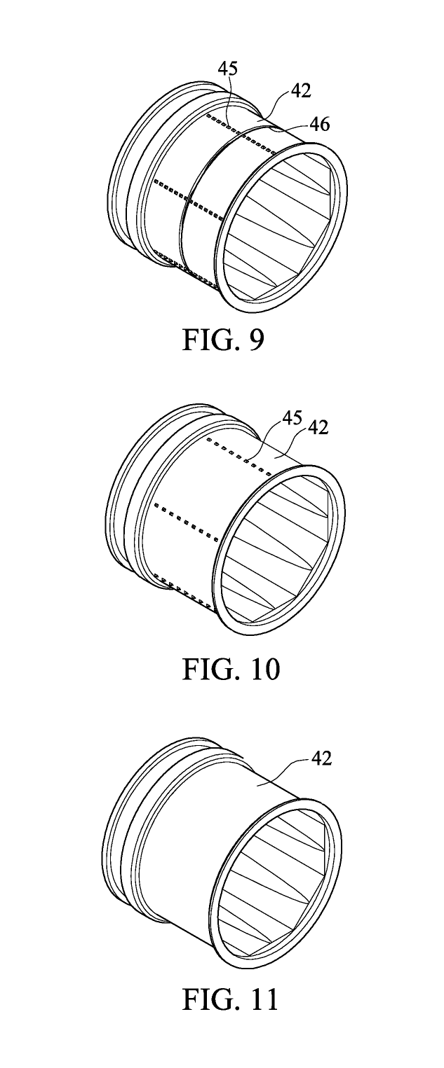

The cord area 41 and the ladder tape area 42 of reel rotor 4 can be integrally or compositely formed. In the present embodiment, the reel rotor 4 is compositely designed. That is, the cord area 41 and the ladder tape area 42 are separately formed and then combined with each other. Reference is next made to FIGS. 9-10, in which multiple bumps 45 are disposed on the surface of the ladder tape area 42 to increase the friction, which further prevents the ladder tape 7 from slipping. A thin groove 46 is surroundingly disposed on the ladder tape area 42, in order to be applied to thin ladder tape. As shown in FIG. 11, the surface of the ladder tape area 42 is a smooth surface.

A plurality of fixing bases 5 are disposed at a position that is at the bottom of the upper track 1 and corresponding to the plurality of reel rotors 4. The bottom of the upper track 1 can be disposed with multiple openings 13 (as shown in FIG. 6), for exposing the bottom of the fixing based 5. The bottom of the fixing base 5 can be leveled with the bottom of the upper track 1. The plurality of fixing bases 5 are disposed below the plurality of reel rotors 4, and a fixing base 5 is disposed corresponding to the bottom of each of the reel rotors 4. The fixing base 5 has a bottom plate 51, and it can further have two side plates 52. The two side plates 52 connect to the two sides of the bottom plate 51 and extend upwardly. An accommodation room 53 is formed between the bottom plate 51 and the two side plates 53, and the plurality of reel rotors 4 are contained in the accommodation room 53. Undertaking surfaces 55, 56 in a round concave arc shape are disposed on the fixing base 5, and the outer rim of the reel rotor 4 is disposed on the undertaking surfaces 55, 56 to support the reel rotor 4 and to guide the reel rotor 4 to rotate.

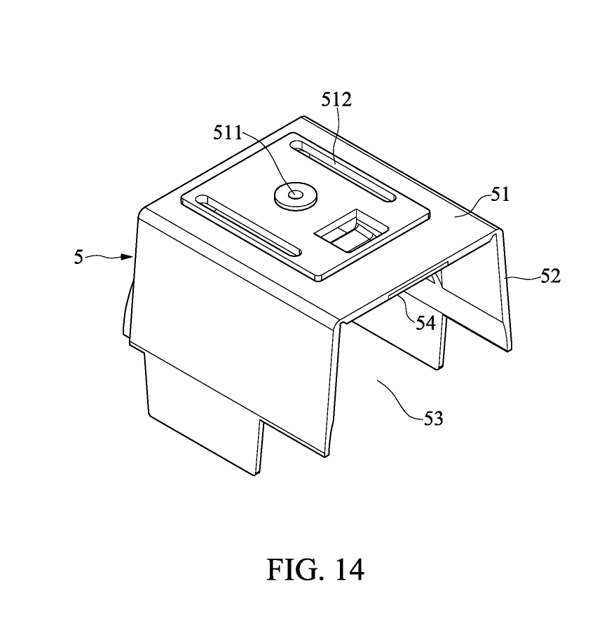

A cord guiding hole 511 and two ladder tape guiding grooves 512 (as shown in FIG. 14) are disposed on the bottom plate 51. The cord guiding hole 511 is disposed at the center of the bottom plate 51 and the two ladder tape guiding grooves 512 can be disposed at the two sides of the bottom plate 51. The cord guiding hole 511 and the two ladder tape guiding grooves 512 are disposed below the ladder tape area 42 of the reel rotor 4, and the two ladder tape guiding grooves 512 can guide the ladder tape 7 to be disposed across the ladder tape area 42 of the reel rotor 4.

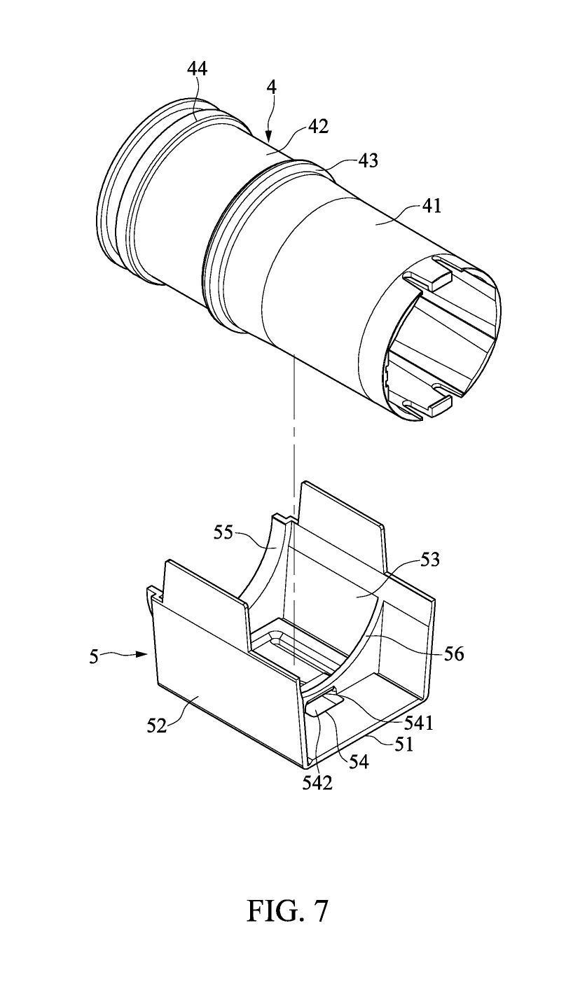

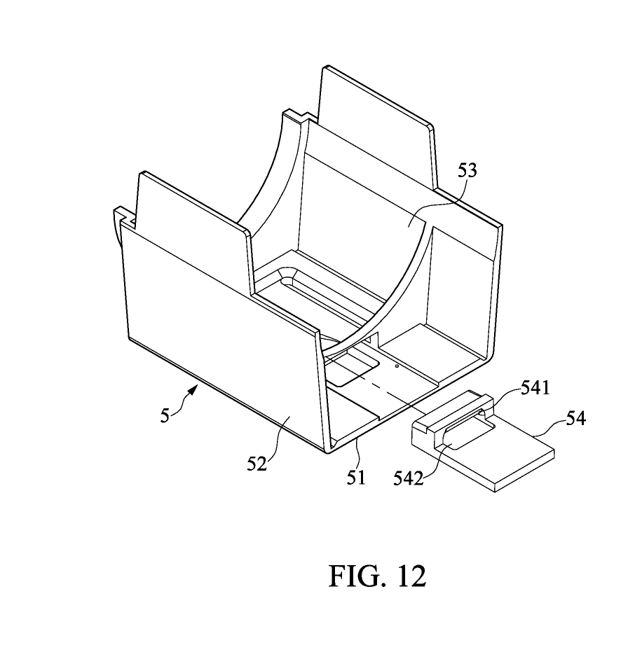

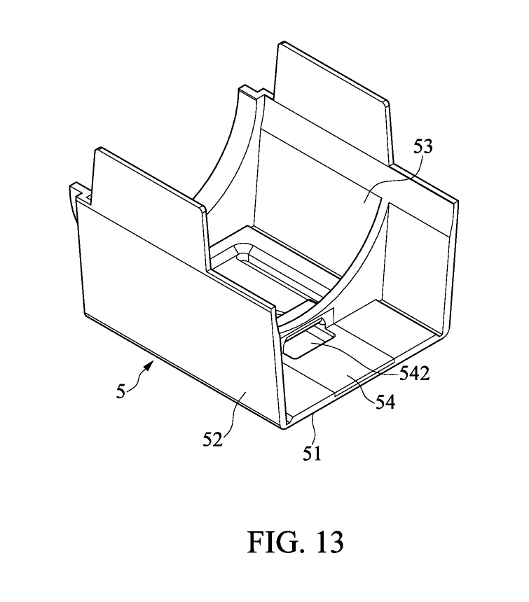

A lateral plate 54 is disposed on the bottom plate 51. The lateral plate 54 can be integrally formed on the bottom plate 51 (as shown in FIG. 7). The lateral plate 54 can be compositely formed on the bottom plate (as shown in FIGS. 12-14). The lateral plate 54 is disposed close to a junction of the rope-pulling area 41 and the ladder tape area 42 of the reel rotor 4. The lateral plate 54 can be disposed above the bottom plate 51, and the lateral plate 54 can be disposed below the reel rotor 4. The cord guiding hole 511 and the lateral plate 54 can guide the lift cord 6 to wind at the cord area 41 of the reel rotor 4, so as to allow the lift cords 6 and the ladder tape 7 to be respectively winded on and disposed across the cord area 41 and the ladder tape area 42 of the reel rotor 4, thereby further allowing the lift, cord 6 and the ladder tape 7 to be staggered, which implies that the lift cord 6 and the ladder tape 7 can be disposed in parallel.

In the present embodiment, the lateral plate 54 is disposed on the bottom plate 51 through engagement or the like. The lateral plate 54 has a lateral portion 541 and a through hole 542, in which the lateral portion 541 and the through hole 542 are staggeringly disposed. The through hole 542 is disposed below the lateral portion 541, the through hole 542 passes through a top portion of the lateral plate 54, and the lateral portion 541 and the through hole 542 of the lateral plate 54 can guide the lift cords 6 to deviate to wind at the cord area 41 of the reel rotor 4.

The lift cords 6 are respectively winded at the pulling area 41 of the reel rotor, and the lift cords 6 pass through slots 101 of the slats 100. The bottom sides of the lift cords 6 are connected with the bottommost slat 100, so as to allow the reel rotor 4 to wind and release the lift cords 6 to raise and lower the slats 100.

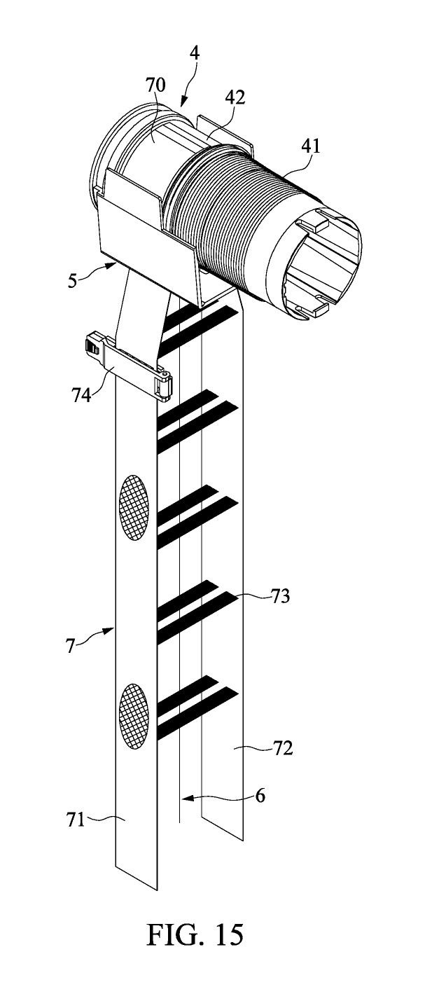

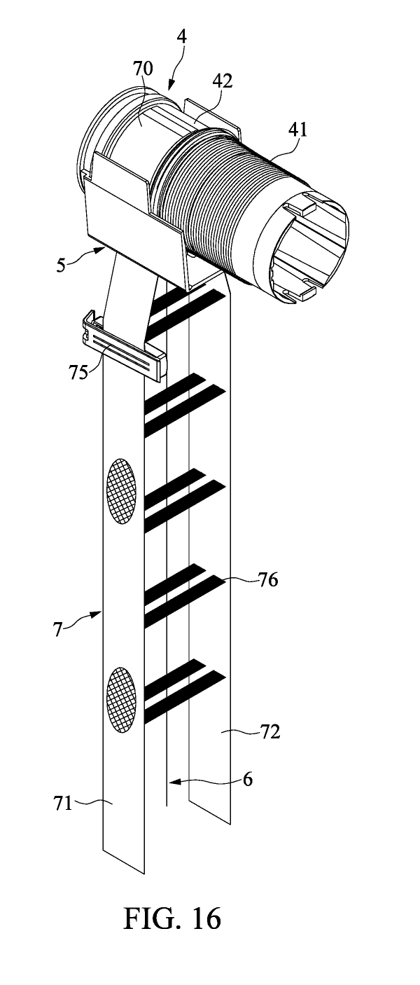

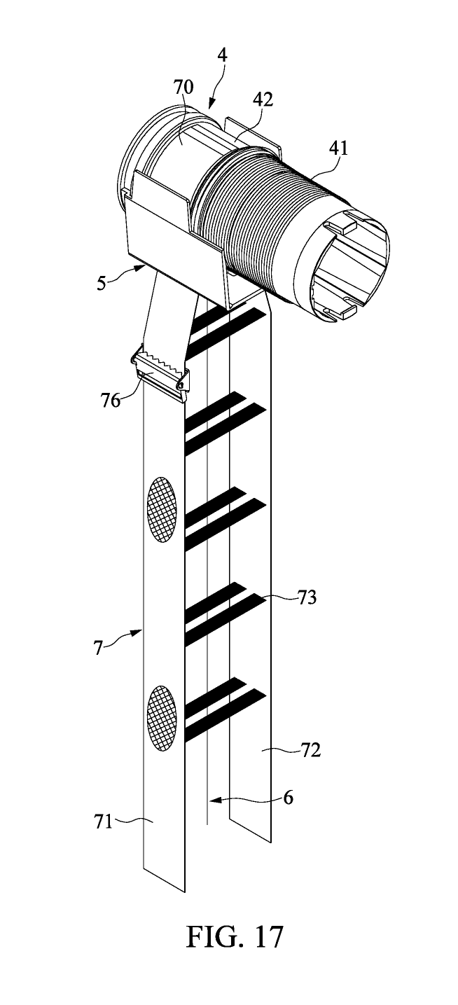

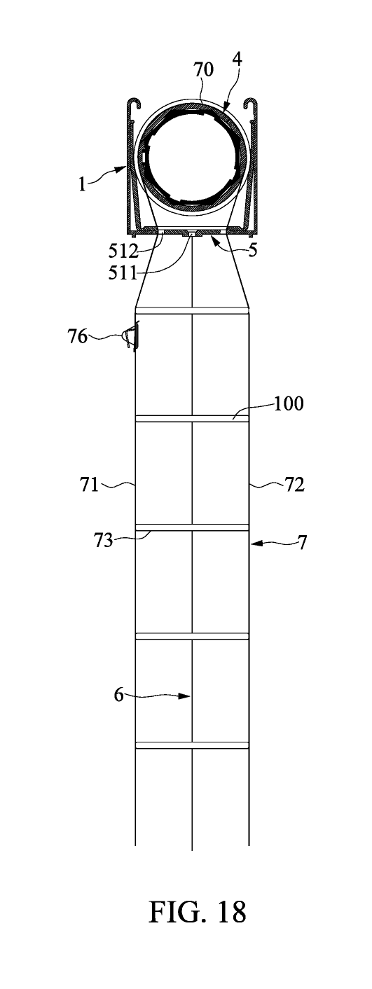

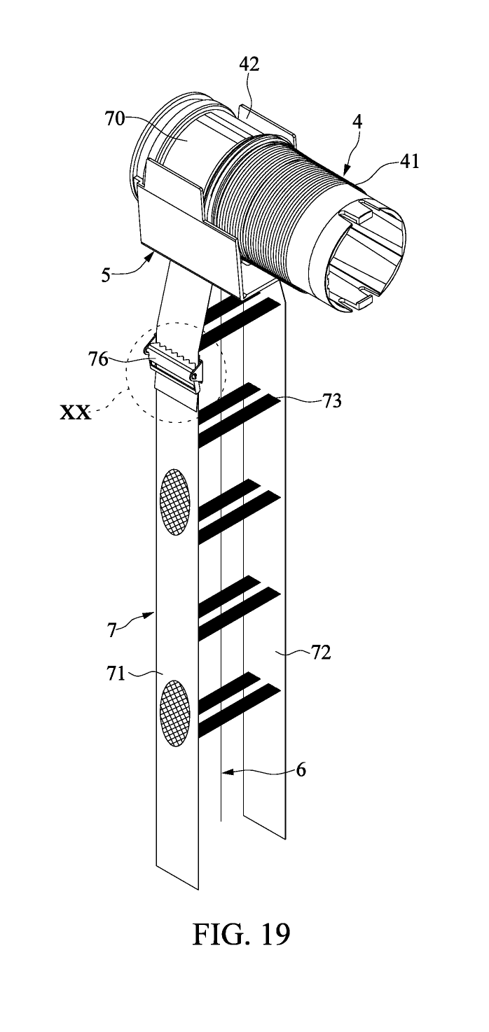

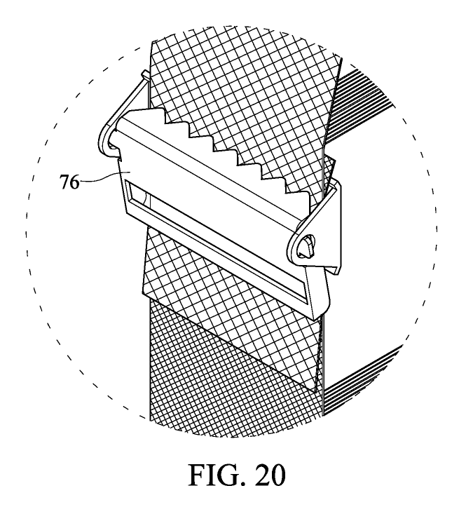

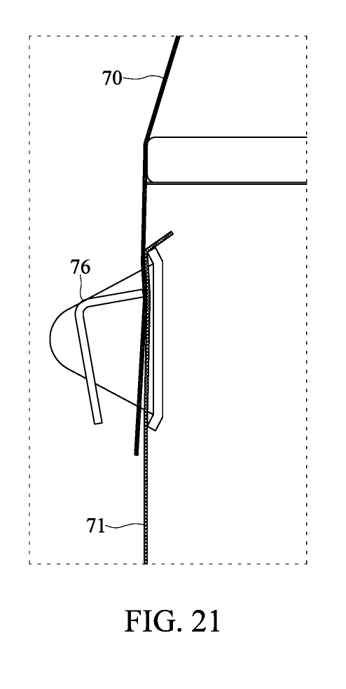

Each of the ladder tapes 7 has two belt portions 71, 72 and a middle part 70, and the two belt portions 71, 72 connect with the two ends of the middle part 70. One of the belt portions 71, 72 (e.g., the belt portion 71) and the middle part 70 can be connected (as shown in FIGS. 19-21), by pressing belt connection, ultrasound welding, suture bonding, ziplock strip connection, buckling connection, locking connection, pinning connection or Velcro bonding connection. As shown in FIG. 15, the ladder tape 7 is connected by pressing belt 74. As shown in FIG. 16, the ladder tape 7 is connected by ziplock strip 75. As shown in FIG. 17, the ladder tape 7 is connected by fixed adjusting buckle 76.

Each ladder tape 7 is a wide belt body, and the middle parts 70 of the plurality of ladder tapes 7 are disposed across the ladder tape area 42 of the reel rotor 4. The two belt portions 71, 72 are disposed at the two sides of the slats 100, a plurality of bearing portions 73 are disposed between the two belt portions 71, 72, and the bearing portions 73 are disposed intervally. The slats 100 are disposed on the hearing portions 73, which makes the slats intervally disposed, so as to allow the plurality of reel rotors 4 to drive the ladder tapes 7 to adjust the inclination angle of each of the slats 100, thereby adjusting lights. The ladder tapes 7 correspond to the slots 101 of the slats 100, and when the slats 100 are adjusted into a light-shielding mode, the slots 101 of the slats 100 are able to be shielded by the ladder tapes 7.

The effects of the present disclosure are that a cord area and a ladder tape area are respectively formed on the surfaces of the plurality of reel rotors, in which the ladder tape area is next to the cord area, so as to allow the cord area and the ladder tape area to be disposed on the reel rotors in parallel. The plurality of fixing bases are disposed at a position that is at the bottom of the upper track and corresponding to the plurality of reel rotors, and a cord guiding hole and two ladder tape guiding grooves are disposed on the bottom plate, and the lateral plate is disposed close to a junction of the cord area and the ladder tape area of the reel rotor. The cord guiding hole and the lateral plate of the plurality of fixing bases are able to guide the plurality of lift cords to wind at the cord area of the reel rotor, and the ladder tape guiding grooves of the plurality of fixing bases are able to guide the ladder tapes to be disposed across the ladder tape area of the reel rotor. Each ladder tape is a wide belt body. That is, when the slats are adjusted into a light-shielding mode, the slots of the slats are able to be shielded by the ladder tapes, so that a better light shielding effect is achieved. Moreover, as each ladder tape is a wide belt body and unnecessary to be connected with ladder strings, the manufacturing process and cost can be saved.

The description illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A reeling device for automated venetians having a plurality of slats, the plurality of slats being disposed with slots, the reeling device comprising:
an upper track with an accommodation space formed therein;
a transmission tube being disposed in the accommodation space of the upper track;
an electric motor connected with the transmission tube, configured to drive the transmission tube to rotate;
a plurality of reel rotors being intervally disposed on the transmission tube and sleeved on the transmission tube, a cord area and a ladder tape area being respectively formed on the surfaces of the plurality of reel rotors, in which the ladder tape area is next to the cord area, so as to allow the cord area and the ladder tape area to be disposed on the reel rotors in parallel;
a plurality of fixing bases being disposed at a position that is at the bottom of the upper track and corresponding to the plurality of reel rotors, the plurality of fixing bases being disposed below the plurality of reel rotors, the plurality of fixing bases respectively having a bottom plate, a cord guiding hole and two ladder tape guiding grooves being disposed on the bottom plate, the cord guiding hole and the two ladder tape guiding grooves being disposed below the ladder tape of the plurality of reel rotors, a lateral plate being disposed on the bottom plate, and the lateral plate being disposed close to a junction of the cord area and the ladder tape area of the reel rotor;
a plurality of lift cords, the cord guiding hole and the lateral plate of the plurality of fixing bases being able to guide the plurality of lift cords to wind at the cord area of the reel rotor, the plurality of lift cords passing through the slots of the slats, and the bottom sides of the plurality of lift cords being connected with the bottommost slat, so as to allow the plurality of reel rotors to wind and release the lift cords to raise and lower the slats; and
a plurality of ladder tapes, the ladder tape guiding grooves of the plurality of fixing bases being able to guide the ladder tapes to be disposed across the ladder tape area of the reel rotor, each ladder tape being a wide belt body, the middle parts of the plurality of ladder tapes being disposed across the ladder tape area of the reel rotor, the plurality of ladder tapes having two belt portions, a plurality of bearing portions being disposed between the two belt portions, the slats being disposed on the bearing portions, so as to allow the plurality of reel rotors to drive the ladder tapes to adjust the inclination angle of each of the slats, the ladder tapes corresponding to the slots of the slats, and when the slats are adjusted into a light-shielding mode, the slots of the slats being able to be shielded by the ladder tapes.

2. The reeling device for automated venetians as claimed in claim 1, wherein each of the plurality of fixing bases has two side plates, the two side plates connect to the two sides of the bottom plate and extend upwardly, an accommodation room is formed between the bottom plate and the two side plates, and the plurality of reel rotors are contained in the accommodation room.

3. The reeling device for automated venetians as claimed in claim 1, wherein the lateral plate is integrally formed with or compositely disposed on the bottom plate.

4. The reeling device for automated venetians as claimed in claim 1, wherein the lateral plate is disposed above the bottom plate, and the lateral plate is disposed below the plurality of reel rotors.

5. The reeling device for automated venetians as claimed in claim 1, wherein the lateral plate has a lateral portion and a through hole, the lateral portion and bottom plate are intervally disposed, the through hole is disposed below the lateral portion, the through hole passes through a top portion of the lateral plate, the lateral portion and the through hole of the lateral plate guide the lift cords to deviate to wind at the cord area of the reel rotor.

6. The reeling device for automated venetians as claimed in claim 1, wherein the cord guiding hole is disposed at the center of the bottom plate, and the tow ladder tape guiding grooves are disposed at the two sides of the bottom plate.

7. The reeling device for automated venetians as claimed in claim 1, wherein each of the ladder tapes has two belt portions and a middle part, the two belt portions connect with the two ends of the middle part, one of the belt portions connects with the middle part by pressing belt connection, ultrasound welding, suture bonding, ziplock strip connection, buckling connection, locking connection, pinning connection or Velcro bonding connection.

8. The reeling device for automated venetians as claimed in claim 1, wherein ring-shaped protrusions are disposed at the two sides of the ladder tape area.

9. The reeling device for automated venetians as claimed in claim 1, wherein multiple bumps are disposed on the surface of the ladder tape area.

10. The reeling device for automated venetians as claimed in claim 1, wherein a thin groove is surroundingly disposed on the ladder area.

11. The reeling device for automated venetians as claimed in claim 1, wherein the surface of the ladder tape area is a smooth surface.

12. The reeling device for automated venetians as claimed in claim 1, wherein the bottom side of the upper track is disposed with a plurality of openings corresponding to the plurality of fixing bases to expose the bottom side of the fixing bases.

13. The reeling device for automated venetians as claimed in claim 1, wherein an undertaking surface in a round concave arc shape is disposed on the fixing base, and the outer rim of the reel rotor is disposed on the undertaking surface to support the reel rotor and to guide the reel rotor to rotate.

14. The reeling device for automated venetians as claimed in claim 1, wherein the cord area and the ladder tape area of the reel rotor are integrally or compositely formed.
